(19) United States
(12) Patent Application Publication
(10) Pub. No.: US 2005/0025994 A1
(43) Pub. Date: Feb. 3, 2005

(54) Organic electroluminescent element and method for producing the same

(76) Inventors: Junichi Hanna, Kanagawa (JP); Akihiko Nakasa, Tokyo (JP); Hiroki Maeda, Tokyo (JP)

Correspondence Address: SEYFARTH SHAW, 55 EAST MONROE STREET, SUITE 4200, CHICAGO, IL, 60603-5803, US

(21) Appl. No.: 10/896,820

(22) Filed: Jul. 22, 2004

(30) Foreign Application Priority Data
Jul. 29, 2003 (JP) 2003-202878

(51) Int. Cl. H05B 33/12; H05B 33/10

(52) U.S. Cl. 428/690; 428/917; 428/1.1; 313/504; 313/506; 156/67; 156/182

(57) ABSTRACT

The present invention provides an organic electroluminescent element comprising a light emitting layer having a good charge transfer characteristic, capable of easily injecting the charge into the light emitting layer, and a method for producing an organic electroluminescent element with a stable quality. The object can be solved by an organic EL element provided with a substrate plate having a first electrode, a substrate plate having a second electrode, and a light emitting layer comprising a liquid crystalline organic semiconductor material and a light emitting material and disposed between the substrate plates, wherein an organic thin layer having a dipole moment for reducing a charge injection barrier between the electrodes and the light emitting layer is formed between the first electrode and the light emitting layer and/or between the second electrode and the light emitting layer. The organic EL element is produced by forming an organic thin layer having a dipole moment on a substrate plate having a first electrode and/or a substrate plate having a second electrode, disposing the substrate plates so as to face the electrodes each other while forming a gap portion, and injecting a liquid crystalline organic material for a light emitting layer to the gap portion between the electrodes to form a light emitting layer.

### BACKGROUND OF THE INVENTION

1. Field of the Invention

The present invention relates to an organic electroluminescent element and a method for producing the same. Particularly, it relates to an organic electroluminescent element provided with a light emitting layer comprising a liquid crystalline organic material and a light emitting material having excellent charge mobility, and a method for producing the same.

2. Description of the Related Art

An organic electroluminescent element (hereinafter it is referred to as an organic EL element) is a charge injection type self light emission type device, utilizing the light emission generated at the time of re-coupling an electron reaching at a light emitting layer and a positive hole. Such an organic EL element has been developed actively since 1987 when T. W. Tang, et al. proved that an element comprising laminated thin films of a fluorescent metal chelate complex and a diamine based molecule emits a light emission of a high luminance with a low driving voltage.

The element configuration of the organic EL element comprises cathode/organic layer/anode. The organic layer thereof in general has a two layer structure comprising a light emitting layer and a positive hole injection layer, or a three layer structure comprising an electron transportation layer, a light emitting layer and a positive hole transporting layer. In the organic EL element, it is necessary to supply the charge (positive hole, electron) to the light emitting material to be the center of the light emission efficiently and quickly. For that purpose, a charge transporting material is included in the light emitting layer, a positive hole transporting layer is provided between the anode and the light emitting layer, or an electron transporting layer is provided between the cathode and the light emitting layer.

According to the organic EL element, in order to obtain the high light emitting efficiency, it is necessary to efficiently inject the charge (positive hole, electron) from the electrode to the organic layer, however, since the energy gap between the anode and cathode, and the organic layer such as the light emitting layer is large so that the charge cannot be injected easily. Therefore, conventionally, the work function of the anode is increased, a positive hole injection layer is provided between the anode and the organic layer, the work function of the cathode is reduced, or an electron injection layer is provided between the cathode and the organic layer so as to reduce the energy gap between the electrode and the organic layer.

Under such circumstances, an organic EL element with an organic thin layer having a dipole moment with an effect of the electric double layers on the surface on the light emitting layer side of the anode formed as the positive hole injection layer has been reported (see, for example, Japanese Patent Application Laid-Open (JP-A) No. 2002-270369). The report discloses that the driving voltage can be lowered by facilitating the positive hole injection from the anode to the light emitting layer by reducing the energy gap between the electrode and the organic layer according to the function of the organic thin layer having the dipole moment. Moreover, an organic EL element having an organic thin layer comprising a dipole compound having a functional group of, for example, a π electron system formed on the surface of the light emitting layer side of the anode as a positive hole injection layer has been reported (see, for example, Japanese translation of PCT international application No.2001-512145). The report discloses that the charge injection from the electrode to the light emitting layer can be facilitated by the function of the organic thin layer serving as the electric double layers for reducing the energy gap between the electrode and the organic layer.

The above-mentioned conventional organic EL element is formed by depositing a transparent anode such as an ITO or the like on a substrate, applying a dip process or depositing a charge injection layer comprising an organic thin layer having the above-mentioned dipole moment thereon, depositing or coating an organic layer thereon, forming as required a charge injection layer comprising an organic thin layer having a dipole moment thereon, furthermore, depositing a cathode thereon, and finally providing a sealing base material.

According to the conventional production process, even if the charge injection to the organic layer is facilitated by forming the charge injection layer comprising the organic thin layer having the dipole moment, for example, in the case the organic layer is deposited on the organic thin layer having the dipole moment on the anode, or in the case the cathode is deposited on the organic thin layer having the dipole moment on the light emitting layer, the organic thin layer having the dipole moment maybe damaged drastically so that the charge injection efficiency may not be improved sufficiently.

On the other hand, most of the organic layers such as a light emitting layer of the organic EL element do not have a sufficient charge mobility so far, and thus the thickness of the organic layer provided between the electrodes is made thin to about several tens nm so as to reduce the charge injection voltage. However, since the organic EL element having a thin organic layer can easily generate the short circuit between the facing electrodes due to the thin film thickness, and furthermore, a problem is involved in that the production process should be handled cautiously.

As a material having a high charge mobility, a liquid crystalline organic semiconductor material is known. As to the liquid crystalline organic semiconductor material having a high charge mobility, for example, Haarer, et al. have reported that a high speed positive hole mobility of 10⁻¹ cm²/V·s is shown in the mesophase of a long chain triphenylene based compound as a representative discotique liquid crystal (see, for example, Nature, vol. 371, p. 141 (1994)), and Hanna, et al. have reported that a high speed charge mobility of 10⁻² cm²/V·s is shown by the smectic E (SmE) phase of the bar like liquid crystal having a phenylnaphthalene skeleton (see, for example, Appl. Phys. Lett., vol. 73, No. 25, p. 3733 (1998)). These liquid crystalline organic semiconductor materials are expected to be a film forming material comprising a channel area of an organic semiconductor element.

### SUMMARY OF THE INVENTION

The present invention has been achieved in order to solve the above-mentioned problems in the organic EL elements, and an object thereof is to provide an organic electroluminescent element comprising a light emitting layer having a good charge transfer characteristic, capable of easily injecting the charge into the light emitting layer, and a method for producing an organic electroluminescent element with a stable quality.

In order to solve the above-mentioned problems, an organic electroluminescent element of the present invention is provided with a substrate plate having a first electrode, a substrate plate having a second electrode, and a light emitting layer comprising a liquid crystalline organic material and disposed between the substrate plates, wherein an organic thin layer having a dipole moment is formed between the first electrode and the light emitting layer and/or between the second electrode and the light emitting layer.

According to the invention, since the organic thin layer having the dipole moment capable of reducing the difference of the work function of the electrode and the work function of the light emitting layer (that is, capable of reducing the charge injection barrier present therebetween) is formed between the first electrode and the light emitting layer and/or between the second electrode and the light emitting layer, the charge injection to the light emitting layer can be facilitated owing to the function of the organic thin layer.

According to the organic electroluminescent element of the present invention, the liquid crystalline organic material contains a liquid crystalline organic semiconductor material.

According to the invention, since the liquid crystalline organic material including the liquid crystalline organic semiconductor material has the flowability, the light emitting layer can be formed by injecting the liquid crystalline organic material or the like. As a result, the organic thin layer cannot be damaged by the conventional deposition so that the charge injection efficiency cannot be deteriorated. Furthermore, since the liquid crystalline organic material includes the liquid crystalline organic semiconductor material, a light emitting layer having a good charge mobility can be formed so that a thick light emitting layer can be formed. As a result, a problem of the short circuit between the electrodes or the like can be eliminated, and furthermore, an organic EL element with a good production process handling can be formed.

According to the organic electroluminescent element of the present invention, the liquid crystalline organic semiconductor material has a liquid crystalline molecule comprising a framework structure containing “L” pieces of 6π-electron system aromatic ring, “M” pieces of 8π-electron system aromatic ring, “N” pieces of 10π-electron system aromatic ring, “O” pieces of 12π-electron system aromatic ring, “P” pieces of 14π-electron system aromatic ring, “Q” pieces of 16π-electron system aromatic ring, “R” pieces of 18π-electron system aromatic ring, “S” pieces of 20π-electron system aromatic ring, “T” pieces of 22π-electron system aromatic ring, “U” pieces of 24π-electron system aromatic ring, “V” pieces of 26π-electron system aromatic ring, wherein L, M, N, O, P, Q, R, S, T, U and V respectively represent an integer number from 0 to 6; and L+M+N+O+P+Q+R+S+T+U+V=1 to 6, and chain molecule(s) introduced to a terminal or both terminals of the framework structure.

According to the invention, since the liquid crystalline molecules are present with the framework structures adjacent with each other and the chain like molecules thereof are present adjacent with each other, the area with the framework structures adjacent with each other is a molecule agglomerated part having a high self organization property. At the molecule agglomerated part, the electron or the positive hole can easily generate the hopping conduction with a high charge mobility. As a result, the thickness of the light emitting layer as the charge transportation length needs not be extremely thin so that the problem of the short circuit between the electrodes or the problem of handling can be solved. Furthermore, since the light emitting layer comprises the liquid crystalline organic material for the light emitting layer having the liquid crystalline organic semiconductor material, the light emitting layer can be formed easily by injecting the material thereof between the facing substrate plates.

According to the organic electroluminescent element of the present invention, the liquid crystalline organic semiconductor material has smectic phase.

According to the organic electroluminescent element of the present invention, the light emitting layer has charge mobility of 10⁻⁶ cm²/V·s or more.

According to the organic electroluminescent element of the present invention, the light emitting layer contains a light emitting material which is a fluorescence low molecular or high molecular compound.

According to the invention, since the light emitting material comprising the fluorescence low molecular or high molecular compound is included in the liquid crystalline organic semiconductor material, the light emitting material can be dispersed homogeneously in the light emitting layer.

According to the organic electroluminescent element of the present invention, the organic thin layer comprises an organic compound having the electric dipole moment represented by a vector having absolute value between 1 debye and 50 debye.

According to the organic electroluminescent element of the present invention, the organic thin layer comprises an organic compound having the electric dipole moment represented by a vector having absolute value between 1 debye and 50 debye, and the vector is directed in such a manner that a positive electrode of the organic compound is located at anode side of the first electrode and the second electrode, and a negative electrode of the organic compound is located at the side of the light emitting layer.

According to the invention, since the organic compound having the dipole moment is bonded chemically to the anode so as to form the organic thin layer having the dipole moment, the positive hole can be injected easily from the anode to the light emitting layer.

According to the organic electroluminescent element of the present invention, the organic thin layer comprises an organic compound having the electric dipole moment represented by a vector having absolute value between 1 debye and 50 debye, and the vector is directed in such a manner that a negative electrode of the organic compound is located at cathode side of the first electrode and the second electrode, and a positive electrode of the organic compound is located at the side of the light emitting layer.

According to the invention, since the organic compound having the dipole moment is bonded chemically to the cathode so as to form the organic thin layer having the dipole moment, the electron can be injected easily from the cathode to the light emitting layer.

Another embodiment of an organic electroluminescent element of the present invention is provided with a substrate plate having a first electrode, a substrate plate having a second electrode, and a light emitting layer comprising an organic material and disposed between the substrate plates, wherein an organic thin layer comprising an ion pair represented by the formula below is formed between the first electrode and the light emitting layer and/or between the second electrode and the light emitting layer. 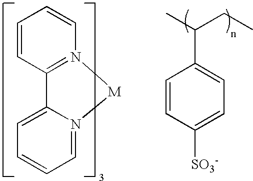
wherein, M is Ru(II), Os(II), Cr(II) or the like.

According to the invention, the organic thin layer formed by the above-mentioned chemical formula can be used preferably as the charge injection layer to the light emitting layer comprising the crystalline organic material, and furthermore, it was found out that it can be used preferably also as the charge injection layer to the light emitting layer comprising the non liquid crystalline conventional organic material. As a result, the organic thin layer formed by the above-mentioned chemical formula can be used as a charge injection layer having a dipole moment with the effect of the electric double layers on the surface on the light emitting layer side of the anode and/or the cathode even when the light emitting layer comprising the organic material other than the liquid crystalline organic material so that a novel organic EL element comprising an organic thin layer having the dipole moment can be provided.

A method for producing an organic electroluminescent element of the present invention for solving the above-mentioned problems comprises a step (A) and any step of (B₁) , (B₂) or (B₃) following the step (A):
(A) forming an organic thin layer having a dipole moment on a substrate plate having a first electrode and/or a substrate plate having a second electrode;
(B₁) disposing the substrate plates so as to face the electrodes each other while forming a gap portion, and injecting a liquid crystalline organic material for a light emitting layer containing a light emitting material to the gap portion between the electrodes to form a light emitting layer;
(B₂) applying a liquid crystalline organic material for a light emitting layer containing a light emitting material on the first electrode or the second electrode to form a light emitting layer, and disposing the substrate plates so that the electrodes are faced each other; and
(B₃) laminating a liquid crystalline organic material for a light emitting layer containing a light emitting material on the first electrode or the second electrode to form a light emitting layer, and disposing the substrate plates so that the electrodes are faced each other.

According to the invention, since the light emitting layer is formed by injecting the liquid crystalline organic material for the light emitting layer to the gap portion formed by disposing the substrate plates so as to face the electrodes each other after forming the organic thin layer having the dipole moment on the electrode of one or both of the substrate plates, an organic EL element without the damage of the deposition in the conventional embodiments can be produced easily.

Also, according to the invention, since the light emitting layer is formed by applying the liquid crystalline organic material for the light emitting layer on either of the electrodes after forming the organic thin layer having the dipole moment on the electrode of one or both of the substrate plates, an organic EL element without the damage of the deposition in the conventional embodiments can be produced easily.

Also, according to the invention, since the light emitting layer is formed by laminating the liquid crystalline organic material for the light emitting layer on either of the electrodes after forming the organic thin layer having the dipole moment on the electrode on one or both of the substrate plates, an organic EL element without the damage of the deposition in the conventional embodiments can be produced easily.

According to the method for producing an organic electroluminescent element of the present invention, the organic thin layer is formed by coating, depositing, spin coating, dipping or printing with the use of a liquid for forming an organic thin layer containing an organic compound having an electric dipole moment.

According to the method for producing an organic electroluminescent element of the present invention, the organic compound is represented by a vector having absolute value between 1 debye and 50 debye.

According to the method for producing an organic electroluminescent element of the present invention, the liquid crystalline organic material for a light emitting layer contains a liquid crystalline organic semiconductor material.

According to the invention, since the liquid crystalline organic material for the light emitting layer containing the liquid crystalline organic semiconductor material has the flowability, the light emitting layer can be formed by injecting the liquid crystalline organic material or the like. As a result, since the organic thin layer cannot be damaged, the charge injection efficiency cannot be lowered. Furthermore, since the liquid crystalline organic material contains the liquid crystalline organic semiconductor material, a light emitting layer having a good charge mobility can be formed easily so that a thick light emitting layer can be formed. Thereby, a problem of the short circuit or the like between the electrodes can be eliminated, and furthermore, the production process handling can be improved.

According to the method for producing an organic electroluminescent element of the present invention, the liquid crystalline organic semiconductor material has a liquid crystalline molecule comprising a framework structure containing “L” pieces of 6π-electron system aromatic ring, “M” pieces of 8π-electron system aromatic ring, “N” pieces of 10π-electron system aromatic ring, “O” pieces of 12π-electron system aromatic ring, “P” pieces of 14π-electron system aromatic ring, “Q” pieces of 16π-electron system aromatic ring, “R” pieces of 18π-electron system aromatic ring, “S” pieces of 20π-electron system aromatic ring, “T” pieces of 22π-electron system aromatic ring, “U” pieces of 24π-electron system aromatic ring, “V” pieces of 26π-electron system aromatic ring, wherein L, M, N, O, P, Q, R, S, T, U and V respectively represent an integer number from 0 to 6; and L+M+N+O+P+Q+R+S+T+U+V−1 to 6, and chain molecule(s) introduced to a terminal or both terminals of the framework structure.

### BRIEF DESCRIPTION OF THE DRAWINGS

FIG. 1 is a cross sectional view of an organic EL element of the present invention.

FIG. 2 is an explanatory diagram of an organic thin layer having a dipole moment formed on an anode.

FIG. 3 is an explanatory diagram of an organic thin layer having a dipole moment formed on a cathode.

FIG. 4 is an electric field-electric current characteristic graph for discussing the charge injection effect of an organic EL element comprising an 8-PNP-04 with a coumarin molecule doped.

FIG. 5 is a voltage-electric current characteristic graph for discussing the charge injection effect of an organic EL element comprising an 8-PNP-04.

FIG. 6 is a PT (photo luminescence) measurement graph of a coumarin molecule.

FIG. 7 is a PL (photo luminescence) measurement graph of an 8-PNP-04.

FIG. 8 is an explanatory diagram of a light emitting mechanism of an organic EL element comprising an 8-PNP-04 with a coumarin molecule doped.

### DETAILED DESCRIPTION OF THE INVENTION

Hereinafter, an organic EL element of the present invention and a method for producing the same will be explained in detail.

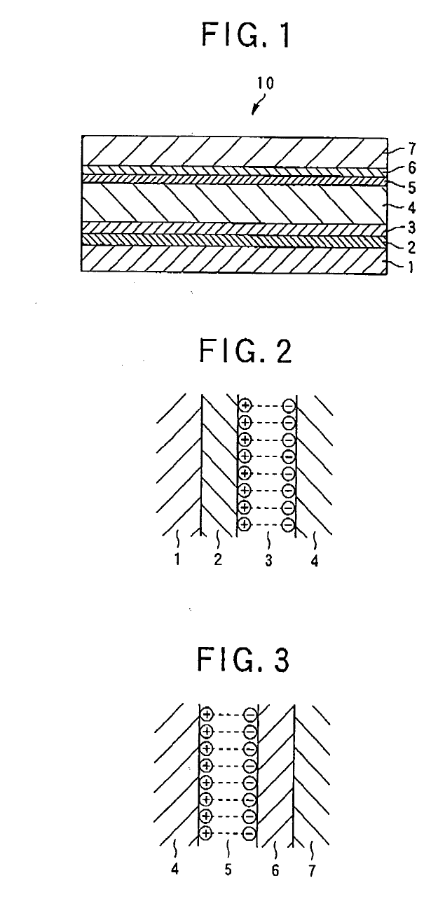

As shown in FIG. 1, an organic EL element 10 of the present invention is provided with a light emitting layer 4 containing a liquid crystalline organic material between a substrate plate 1 with a first electrode 2 (for example, an anode) formed and a substrate plate 7 with a second electrode 6 (for example, a cathode) formed, with an organic thin layers 3 and 5 having a dipole moment for reducing the difference of the work function of the electrodes 2 and 6 and the work function of the light emitting layer 4 formed between the light emitting layer 4 and the first electrode 2 and/or the light emitting layer 4 and the second electrode 6.

(Substrate Plate)

The substrate plates 1 and 7 disposed on the both sides of the light emitting layer provide a support for the organic EL element 10 of the present invention. It may be either of a flexible material or of a hard material. As the specific examples of the materials to be used, for example, there may be a glass, a quartz, a polyethylene, a polypropylene, a polyethylene terephthalate, a polymethacrylate, a polymethyl methacrylate, a polymethyl acrylate, a polyester, a polycarbonate or the like. In the case a light emitted from the light emitting layer 4 is taken out after passing through the substrate plate 1 side, at least the substrate plate 1 should be a transparent material, however, in the case the light is taken out after passing through the substrate plate 7 side, at least the substrate plate 7 should be a transparent material. Among these examples, in the case a synthetic resin substrate plate is used, it preferably has the gas barrier property. The thickness of the substrate plates 1 and 7 is not particularly limited, and it is in general about 0.5 to 2.0 mm.

(First Electrode, Second Electrode)

As for the first electrode 2 and the second electrode layer 6, whether the transparency is required for the electrode 2 or the electrode 6 depends on the direction of taking out the light emitted from the light emitting layer 4. In the case the light emission is taken out from the substrate plate 1 side, the first electrode 2 should be formed with a transparent material. In the case the light emission is taken out from the substrate plate 7 side, the second electrode 6 should be formed with a transparent material. Either of the first electrode 2 and the second electrode 6 can be an anode or a cathode. Hereafter, explanation is given with the premise that the first electrode 2 is an anode and the second electrode 6 is a cathode.

In the case the first electrode 2 is provided as an anode on the light emitting layer side of the substrate plate 1, the anode functions so as to inject the positive hole to the light emitting layer 4. In the case the second electrode 6 is provided as a cathode on the light emitting layer side of the substrate plate 7, the cathode functions so as to inject the electron to the light emitting layer 4. The electrodes 2 and 6 to function as the anode or the cathode can be formed in general with a metal such as an aluminum, a gold, a silver, a nickel, a palladium, and a platinum or the like, or a metal oxide such as an indium and/or a tin oxide. Moreover, it can be formed also with a conductive polymer or the like such as a polyaniline, a polyacetylene, a polyalkyl thiophene derivative or a polysilane derivative.

The anode and the cathode in general are independently formed on the substrate 1 or the substrate 7 by a method such as a sputtering method and a vacuum deposition method in most cases, and it can be formed also by a wet process such as a coating method and a dipping method. The thickness of the anode and the cathode differs depending on the transparency required to each electrode or the like. In the case the transparency is needed, the light transmittance in the visible light wavelength area of the electrode is in general 60% or more, preferably 80% or more. The thickness in this case is in general about 10 to 1,000 nm, preferably about 20 to 500 nm.

According to the conventional organic EL element, it has been regarded to be preferable that the anode is made of a material having a large work function and the cathode is made of a material having a small work function. However, according to the organic EL element of the present invention, the work function of the electrode can be varied in accordance with the size of the electric dipole moment so that the charge injection characteristics can be improved.

(Light Emitting Layer)

As shown in FIG. 1, the light emitting layer 4 is formed with a liquid crystalline organic material for the light emitting layer between the substrate plate 1 with the first electrode 2 (for example, an anode) and the substrate plate 7 with the second electrode 6 (for example, a cathode) formed. The liquid crystalline organic material for the light emitting layer is a material including a liquid crystalline organic semiconductor material and a light emitting material, which includes the light emitting material to be the light emission center while having a high charge mobility characteristic.

The liquid crystalline organic semiconductor material has a liquid crystalline molecule comprising a framework structure containing “L” pieces of 6π-electron system aromatic ring, “M” pieces of 8π-electron system aromatic ring, “N” pieces of 10π-electron system aromatic ring, “O” pieces of 12π-electron system aromatic ring, “P” pieces of 14π-electron system aromatic ring, “Q” pieces of 16π-electron system aromatic ring, “R” pieces of 18π-electron system aromatic ring, “S” pieces of 20π-electron system aromatic ring, “I” pieces of 22π-electron system aromatic ring, “U” pieces of 24π-electron system aromatic ring, “V” pieces of 26π-electron system aromatic ring, and chain molecule(s) introduced to a terminal or both terminals of the framework structure. L, M, N, O, P, Q, R, S, T, U and V of the electron system aromatic rings comprising the framework structure of the liquid crystalline molecule respectively represent an integer number from 0 to 6 and L+M+N+O+P+Q+R+S+T+U+V=1 to 6.

According to the liquid crystalline molecule, as the 6π-electron system aromatic ring, for example, there may be a benzene ring, a furan ring, a thiophene ring, a pyrrol ring, a 2H-pyrane ring, a 4H-thiopyrane ring, a pyridine ring, an oxazol ring, an isoxazol ring, a thiazol ring, an isothiazol ring, a furazan ring, an imidazol ring, a pyrazol ring, a pyradine ring, a pyrimidine ring, a pyritadine ring and a troboron ring. As the 8π-electron system aromatic ring, for example, there may be a pentalene ring, an indene ring, an indolidine ring and a 4H-quinolidine ring. As the 10π-electron system aromatic ring, for example, there may be a naphthalene ring, an azulene ring, a benzofuran ring, an isobenzofuran ring, a 1-benzothiophene ring, a 2-benzothiophene ring, an indol ring, an isoindol ring, a 2H-chromene ring, a 1H-2-benzobyrane ring, a quinoline ring, an isoquinoline ring, a 1,8-naphthylidine ring, a benzoimidazol ring, a 1H-indazol ring, a benzoxazol ring, a benzothiazol ring, a quinoxaline ring, a quinazoline ring, a cinnoline ring, a pteridine ring, a purine ring and a phtaradine ring. As the 12π-electron system aromatic ring, for example, there may be a heptalene ring, a biphenylene ring, an as-indacene ring, an s-indacene ring, an ananaphthylene ring, a fluorene ring and a phenalene ring. As the 14π-electron system aromatic ring, for example, there may be a phenanthrene ring, an anthracene ring, a carbazol ring, a xanthene ring, anacrydine ring, aphenantridine ring, a perimidine ring, a 1,10-phenanthroline ring, a phenadine ring, a phenarsadine ring and a tetrathiaflubarene ring. As the 16π-electron system aromatic ring, for example, there may be a fluorantene ring, an acephenane trilene ring, an acean trilane ring, a pyrene ring, a thianthrene ring, a phenoxathin ring, a phnoxadine ring and a phenothiadine ring. As the 18π-electron system aromatic ring, for example, there may be a triphenylene ring, a chrysene ring, a naphthacene ring and a preyadene ring. As the 20π-electron system aromatic ring, for example, there maybe a perylene ring. As the 22π-electron system aromatic ring, for example, there may be a bicene ring, a pentaphene ring and a bentacene ring. As the 24π-electron system aromatic ring, for example, there may be a tetraphenylene ring and a coronene ring. As the 26π-electron system aromatic ring, for example, there may be a hexaphene ring, a hexacene ring and a rubicene ring.

As the liquid crystalline molecule, those having at least one kind of the liquid crystalline state at the thermally decomposing temperature or lower. Here, “the thermally decomposing temperature or lower” denotes “in the state with the liquid crystalline molecule itself without thermally decomposed”. The thermally decomposing temperature differs depending on the liquid crystalline molecule to be used. Moreover, “having at least one kind of the liquid crystalline state” denotes “having a plurality of liquid crystalline phases or at least one kind of a liquid crystalline phase even when an element comprising the material of the present invention is used in a temperature range other than the liquid crystalline state. For example, as the smectic phase to be described later (hereinafter, it is referred to as Sm), a plurality of kinds of the liquid crystalline states such as an SmA phase, an SmB phase, and an SmC phase are known. It has a temperature range for providing at least one kind of the liquid crystalline state.

As the examples of the liquid crystalline molecules, for example, there may be those having the framework structures represented by the following formulae 1 to 35.

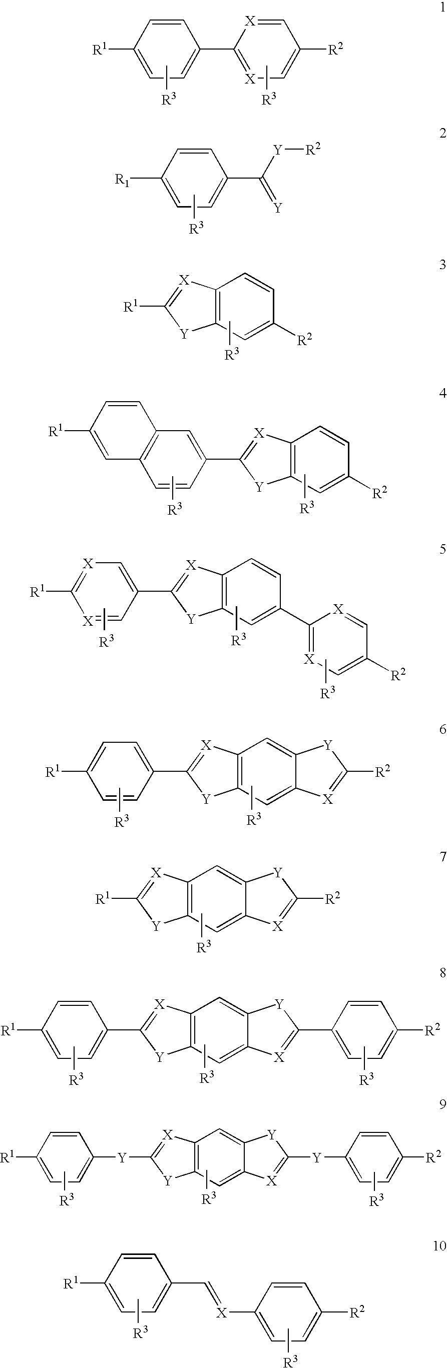

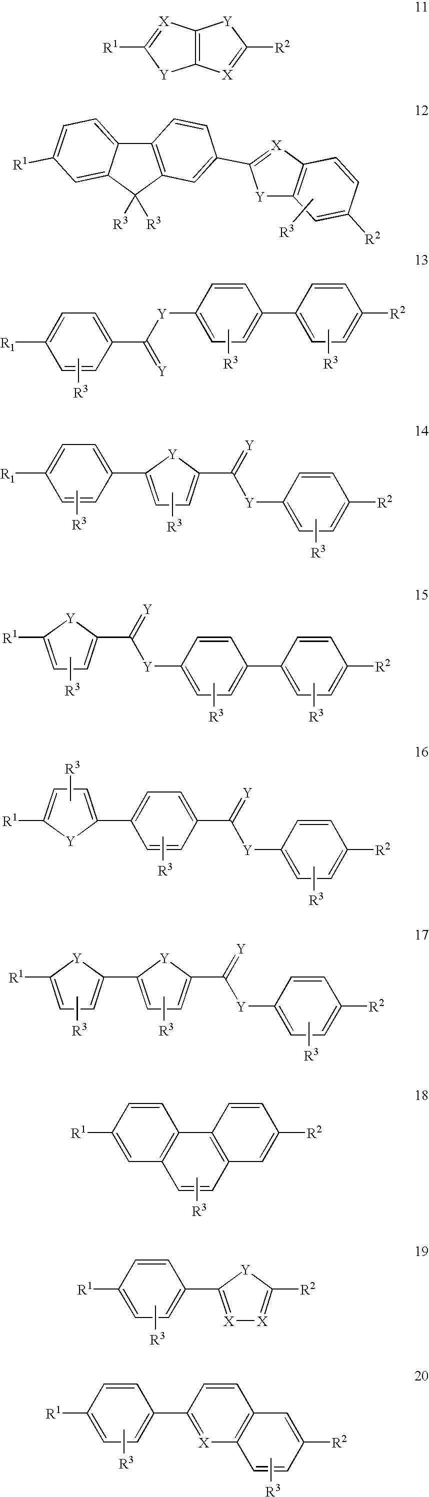

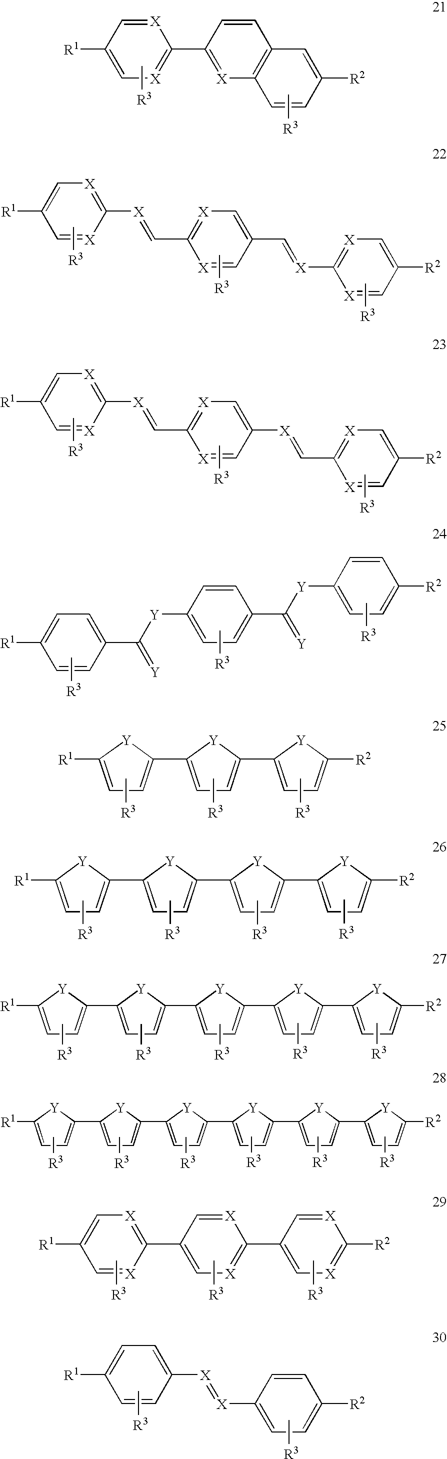

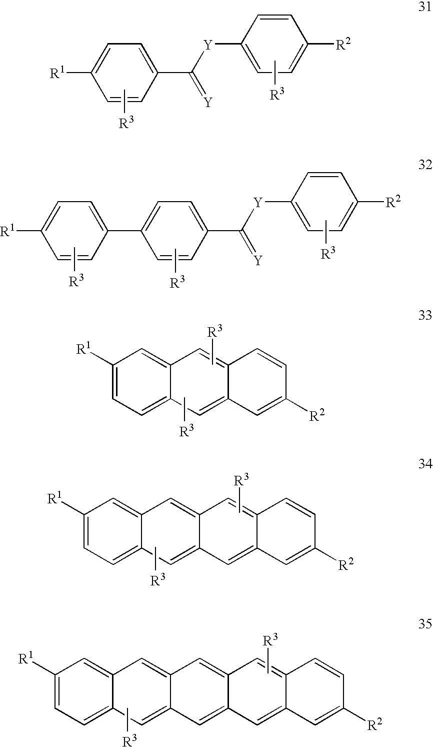

In the above-mentioned formulae, R¹ and R² are a terminal structure shown below, R³ is a trifluoromethyl group, an alkyl group, a nitro group, a halogen atom or a hydrogen atom, X is CH or N, and Y is S or O.

Among the above-mentioned various kinds of liquid crystalline molecules, it is preferable that “the liquid crystalline organic semiconductor material having at least one state” is a material providing a rod like smectic liquid crystalline phase. Since the liquid crystal has the self organizing function, the molecular order is formed spontaneously, and particularly in the case of a smectic phase, a high molecular order such as a molecular crystal can be formed for the charge transporting path.

The light emitting layer 4 formed using the liquid crystalline organic material for the light emitting layer including the liquid crystalline organic semiconductor material having such a smectic phase can provide the excellent charge transporting characteristics such as the molecular crystal. It is particularly preferable that the light emitting layer 4 is formed using a liquid crystalline organic semiconductor material comprising a high order smectic phase.

The light emitting layer 4 accordingly formed has the remarkable effect concerning the charge mobility characteristic of realizing a high speed charge transporting ability for both the high electron and positive hole based on the hopping conduction. That is, the liquid crystalline molecules comprising the light emitting layer 4 generate the self organization according to the presence of the chain like molecules such as the alkyl chain or the like introduced to a terminal or both terminals of the framework structure so as to be oriented extremely orderly. Thus, an area with molecule agglomerated part having the high self organization property is formed in the light emitting layer by the liquid crystalline molecules. In the area, the framework structure portion having the rigid π-electron system aromatic ring of the liquid crystalline molecules are adjacent to the molecules by an extremely short distance. As a result, in the liquid crystalline molecular area, since the high speed electron conduction and the high speed hole conduction are generated based on the hopping conduction according to the enlargement of the overlapping of the π electron orbits, the formed light emitting layer provides the high charge transporting characteristic. The interval between the framework structures in this case is about 0.3 to 0.5 nm. Since the formed light emitting layer has an area with the rigid π-electron system aromatic ring overlapped continuously for a long distance owing to the self organization of the liquid crystalline molecules, it can easily generate the hopping conduction of the electrons and the holes. However, in the case of a liquid crystalline organic semiconductor material not realizing the high molecular order over a long distance such as fine crystals, trapping is generated in the crystal boundary so that a high conductivity cannot be expected.

On the other hand, the liquid crystalline organic semiconductor material providing the smectic crystalline phase has an area with rich chain like molecules. The area functions as a buffer layer for partitioning the charge transporting path of the above-mentioned area (the area as the molecule agglomerated portion having the high self organization property by the liquid crystalline molecules) so as to provide an effect of realizing a large charge transporting anisotropy.

As the specific examples of the chain like molecules comprising the terminal parts of the liquid crystalline molecules, there may be a chain like molecule having H (hydrogen atom), a halogen atom, a cyano group, a nitro group or a hydroxyl group on one terminal of the rigid framework structure, and a substituted or nonsubstituted alkyl group, or a substituted or nonsubstituted alkylthio group on the other terminal. As the examples of the substituted groups in this case, there may be a halogen atom, a cyano group, a sulfo group, an alkoxy carbonyl group, an alkoxy group, a hydroxy group, an aryloxy group, an acyloxy group, an aryl group, an acyl group or the like.

Moreover, there may be a chain like molecule having a substituted or non substituted alkyl group, or a substituted or non substituted alkylthio group on the both terminals. As the examples of the substituted groups in this case, there may be those having the structure of a halogen atom, a cyano group, a sulfo group, an alkoxy carbonyl group, an alkoxy group, a hydroxy group, an aryloxy group, an acyloxy group, an aryl group, an acyl group or the like.

As the specific examples of the liquid crystalline molecule having a smectic liquid crystalline phase, there may be the liquid crystalline molecules such as a 2-(4′-octylphenyl)-6-dodecyloxy naphthalene (it is abbreviated as an 8-PNP-012) represented by the formula 36 below and a 2-(4′-octylphenyl)-6-butyloxy naphthalene (it is abbreviated as an 8-PNP-04) represented by the formula 37 below having a phenyl naphthalene skeleton, a didodecylterthiophene represented by the formula 38 below and a dihexyl terthiophene represented by the formula 39 below having a terthiophene skeleton, and a 2-(4′-heptyloxyphenyl)-6-dodecylthiobenzothiazole represented by the formula 40 below having a phenylbenzothiazol skeleton. These materials provide the transportation of both polarities with the charge transportation mobility by the hopping conduction independent from the electric field strength or the temperature as to either of the electron and the positive hole in the same phase.

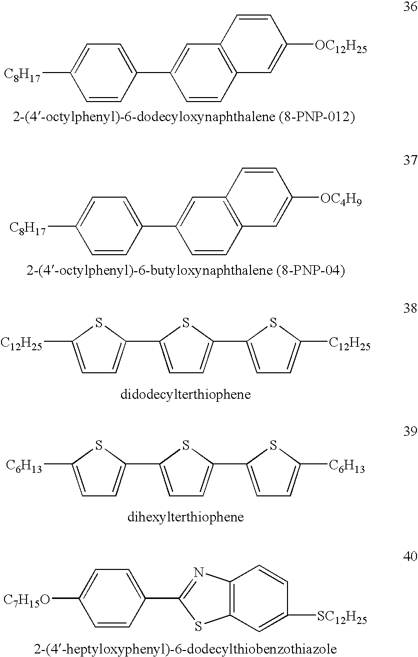

The light emitting material is the other main material for providing the light emitting layer 4, and it is introduced into the self organized liquid crystalline molecules to disperse homogeneously without irregularity.

The light emitting material is not particularly limited as long as it is a material commonly used. For example, a pigment based light emitting material, a metal complex based light emitting material, a polymer based light emitting material or the like can be used.

As the pigment based light emitting material, for example, there may be a cyclopentadiene derivative, a tetraphenyl butadiene derivative, a triphenyl amine derivative, an oxadiazol derivative, a pyrazoloquinoline derivative, a distylyl benzene derivative, a distylyl arylene derivative, a silol derivative, a thiophene ring compound, a pyridine ring compound, a perynon derivative, a perylene derivative, an oligothiophene derivative, a triphmanyl amine derivative, an oxadiazol dimer, a pyrazoline dimer or the like.

As the metal complex based light emitting material, for example, there may be metal complexes having Al, Zn, Be or the like as the central metal, or a rare earth metal such as Tb, Eu, Dy or the like, and having an oxadiazol, a thiadiazol, a phenyl pyridine, a phenyl benzoimidazol, a quinoline structure or the like as the ligand, such as an aluminum quinolinol complex, a benzoquinolinol beryllium complex, a benzoxazol zinc complex, a benzothiazol zinc complex, an azomethyl zinc complex, a porphiline zinc complex, an europium complex or the like.

As the polymer based light emitting material, for example, there may be a polyparaphenylene vinylene derivative, a polythiophene derivative, a polyparaphenylene derivative, a polysilane derivative, a polyacetylene derivative, a polyvinyl carbazol, a polyfluolenonederivative, a polyfluolene derivative, a polyquinoxaline derivative, a copolymer thereof or the like.

For the purpose of improving the light emitting efficiency, changing the light emitting wavelength or the like, an additive such as a doping agent may be added into the light emitting layer. As the doping agent, for example, there may be a perylene derivative, a coumarin derivative, a rubrene derivative, a quinacrydone derivative, a squalium derivative, a porphiline derivative, a styryl pigment, a tetracene derivative, a pyrazoline derivative, a decacyclene, a phenoxazone, a quinoxaline derivative, a carbazol derivative, a fluolene derivative or the like. Moreover, as a dopant, for example, organic compounds having the following structure formulae can be used. For example, organic metal complexes having in the center a heavy metal ion such as Ir (ppy)₃, (ppy)₂Ir(acac), Ir(BO)₃, (BQ)₂Ir(acac), Ir(THP)₃, (THP)₂Ir(acac), Ir(BO)₃, (BO)₂(acac), Ir(BT)₃, (BT)₂Ir(acac), Ir(BTP)₃, (BTP)₂Ir(acac), PtOEP or the like, showing the phosphorescence can be used. In particular, Ir(ppy)₃ is an effective compound as the constituent component of the low molecular carrier transporting material or an organic light emitting layer.

The compounding ratio (weight ratio) of the liquid crystalline organic semiconductor material and the light emitting material in the liquid crystalline organic material for the light emitting layer can be set in consideration of the density extinction. It can be set about in a range of the liquid crystalline organic semiconductor material: the light emitting material=1;100 to 20:100. Specifically, for example, in the case of using the 8-PNP-04 as the liquid crystalline organic semiconductor material and the coumarin 6 as the light emitting material, it is preferably in a range of the liquid crystalline organic semiconductor material: the light emitting material 1:100 to 20:100.

The light emitting layer 4 can be formed by, for example, injecting the liquid crystalline organic material for the light emitting layer containing the above-mentioned liquid crystalline organic semiconductor material and light emitting material as the main materials between the substrate plate 1 with the first electrode 2 (for example, an anode) formed and the substrate plate 7 with the second electrode 6 (for example, a cathode) formed. That is, it can be formed by an extremely simple method similar to the form of the conventional liquid crystal displays of forming a liquid crystalline phase interposed between substrate plates disposed facing with a predetermined interval provided therebetween. Accordingly, the method enables the formation by utilizing the capillary tube phenomenon in a phase with a high flowability or the like.

The liquid crystalline organic material for the light emitting layer can be obtained by a means of mixing a liquid crystalline organic semiconductor material liquid and a light emitting material liquid preliminarily dissolved independently in a common solvent, and eliminating the solvent by drying under the reduced pressure or the like.

Moreover, since the liquid crystalline organic material for the light emitting layer has the flowability in the temperature maintaining the liquid crystalline state, it can form a light emitting layer having an even charge mobility characteristic by coating extremely easily over a large area. As the coating method at the time, a spin coating, an ink jet method, a die coating and other printing methods can be used.

The interval between the substrate plates to have the injection of the liquid crystalline organic material for the light emitting layer can be set optionally according to the charge mobility of the formed light emitting layer. For example, in the case the charge mobility of the light emitting layer is about 10⁻³ to 10⁻² cm²/Vs, it is injected between the substrate plates with an interval of about 0.1 to 10 μm, and the light emitting layer 4 of the same thickness as the interval, that is, the light emitting layer 4 of the 0.1 to 10 μm thickness is formed.

Accordingly, a thick light emitting layer having good charge mobility can be formed so as to eliminate the problem of the short circuit between the electrodes or the like, and an organic EL element with the good production process handling can be formed.

Since the liquid crystalline molecules can easily be oriented to the certain orientation or direction, by orienting the liquid crystalline molecules in the light emitting layer to the certain orientation or direction, the liquid crystalline molecules can be arranged regularly like the molecular crystals so that the average value of the inter molecular distance in the molecule layer derived from the smectic phase of the liquid crystalline molecules can be made extremely small to 0.3 to 0.4 nm. The electron interaction in the molecules with each other of the light emitting layer with the crystalline state formed by the inter molecular distance becomes extremely large so that the effects of a large carrier hopping probability and a high charge transporting characteristic can be exhibited. For example, in the case the average value of the inter molecular distance of the liquid crystalline molecules having the smectic liquid crystalline property represented by the formula 28 is 0.3 to 0.4 nm, the charge mobility has a high charge transporting characteristic of 10⁻³ to 10⁻² cm²/V·s.

(Organic Thin Film Having the Dipole Moment)

The organic thin layers 3 and 5 having the dipole moment are formed between the light emitting layer 4 and the first electrode 2 and/or between the light emitting layer 4 and the second electrode 6 so as to reduce the difference between the work function of the electrodes 2 and 6 and the work function of the light emitting layer 4. That is, it reduces the charge injection barrier between the light emitting layer 4 and the first electrode 2 and/or between the light emitting layer 4 and the second electrode 6. Specifically, in the case the first electrode 2 is an anode, the organic thin layer 3 having the dipole moment formed on the first electrode functions as a positive hole injection film for facilitating the injection of the positive hole into the light emitting layer 4, and in the case the second electrode 6 is a cathode, the organic thin layer 5 having the dipole moment formed on the second electrode functions as an electron injection film for facilitating the injection of the electron into the light emitting layer 4.

First, the organic thin layer 3 having the dipole moment as the positive hole injection film will be explained.

The organic thin layer 3 having the dipole moment as the positive hole injection film is made of an organic compound having the electric dipole moment represented by a vector having its absolute value between 1 debye and 50 debye, with the vector orientation of the positive pole of the organic compound on the anode (first electrode 2) side and the negative pole of the organic compound on the light emitting layer 4 side. Since the organic thin layer having the dipole moment is formed by chemically coupling with the anode, the positive hole can be injected easily from the anode 2 to the light emitting layer 4.

Specifically, the organic thin layer forming material having the dipole moment (the organic compound having the electric dipole moment represented by a vector having its absolute value between 1 debye and 50 debye) can be selected according to the HOMO level of the above-mentioned light emitting layer 4. For example, in the case of the light emitting layer 4 with a 6-(4′-octyl phenyl)-2-butyloxy naphthalene (hereinafter, it is referred to as the 8-PNP-04) formed as the liquid crystalline molecule, the value of the HOMO of the light emitting layer 4 is 6.0 eV, and the work function with the first electrode 2 (anode) formed with an ITO is 4.7 eV. Therefore, an injecting material for reducing the injection barrier of about 1.3 eV as the energy gap of the light emitting layer and the anode can be selected.

According to the present invention, an organic thin layer having the dipole moment with the structure represented by the formula 41 below gathered to the interface on the light emitting layer side of the first electrode 2 (anode) is formed. Here, Y is a linking group with respect to the electrode, X is a substituent group, and Ar is an aromatic hydrocarbon ring or an aromatic heterocycle.
Y—Ar—X— 41

In the formula 41, the linking group Y bonds with the anode surface so that an organic thin layer having the dipole moment can be formed by gathering the same. Here, “the organic thin layer having the dipole moment” denotes a thin film having the thickness corresponding to the size of one molecule. Although the structure represented by the formula 41 may be partially bonded covalently so as to form a dimer, trimer or oligomer like structure, the thickness of the layer is of the one molecule size.

In general, the linking group Y is linked by the reaction with a reactive functional group (in many cases a hydroxyl group) present on the anode surface. FIG. 2 is a schematic diagram of the organic thin layer 3 having the dipole moment formed on the surface of the anode 2 provided by orienting the linking group Y and the substituent group X on the both sides of Ar comprising an aromatic hydrocarbon ring or an aromatic heterocycle. According to the electric field by the electrical double layer comprising the organic thin layer 3 having the dipole moment, the work function of the anode 2 can be increased.

The linking group Y is a group including at least an oxygen atom and a halogen atom. It is selected preferably from the following groups:

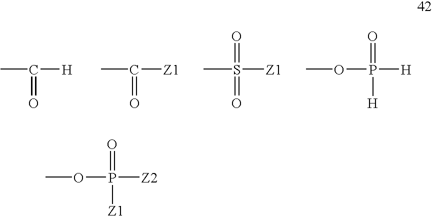

In the formula 42, each of Z1 and Z2 is independently a halogen atom, particularly preferably a chlorine atom.

Ar is a divalent aromatic hydrocarbon ring or an aromatic heterocycle having a substituent X. It is preferably a divalent group comprising a 5 to 6 membered single ring, or bonding the same by 2 or 3 by condensation or directly. Particularly, a benzene, a naphthalene, a biphenyl, an anthracene, a thiophene, a furan, a pyridine or the like is preferable.

As the substituent group X, there may be preferably a hydrogen atom; a halogen atom such as a chlorine atom or the like; a nitro group; an alkyl group having 1 to 6 carbon atoms such as a methyl group, an ethyl group or the like; an aralkyl group such as a benzyl group or the like; an alkenyl group such as a vinyl group or the like; a cyano group; an alkynyl group such as an acetylene group or the like; an amide group; an acyl group such as an acetyl group or the like; an alkoxy carbonyl group having 1 to 6 carbon atoms such as a methoxy carbonyl group, an ethoxy carbonyl group or the like; a carboxyl group; an alkoxy group having 1 to 6 carbon atoms such as a methoxy group, an ethoxy group or the like; an aryloxy group such as a phenoxy group, a benzyloxy group or the like; a haloalkyl group such as a trifluoro methyl group or the like; a thiocyano group; an alkyl sulfonyl group such as a methane sulfonyl group or the like; or a sulfone amide group. Particularly, it is preferably selected from a halogen atom, a haloalkyl group, a cyano group and a nitro group.

As the substituent group X, particularly, an electron attractive group is preferably selected among the above-mentioned groups. Here, the electron attractive group is a substituent group having a positive Hammett constant (am, σp). According to the present invention, since the compound 41 having the Ar portion as a pie covalent system is used, the electrical double layer effect can be sufficiently utilized without the insulating material formation as in the non covalent system straight chain alkyl compound in the Ar portion.

Next, the organic thin layer 5 having the dipole moment as the electron injection film will be explained.

The organic thin layer having the dipole moment as the electron injection film is made of an organic compound having an electric dipole moment represented by a vector having its absolute value between 1 debye and 50 debye, with the vector orientation having the negative pole of the organic compound on the cathode (second electrode 6) side and the positive pole of the organic compound on the light emitting layer side. Since the organic compound having the dipole moment is formed by chemically bonding with the cathode, the electron can be injected easily from the cathode 6 to the light emitting layer 4.

Specifically, the organic thin layer forming material having the dipole moment (the organic compound having the electric dipole moment represented by a vector having its absolute value between 1 debye and 50 debye) is selected according to the LUMO level of the above-mentioned light emitting layer 4. For example, in the case of the light emitting layer 4 formed as the liquid crystalline molecule of the 8-PNP-04, the LUMO level value of the light emitting layer 4 is 1.6 eV, and the work function at the time of forming the second electrode 6 (cathode) with an ITO is 4.7 eV. Therefore, an injecting material for reducing the injection barrier of about 2.4 eV as the energy gap between the light emitting layer and the cathode is selected.

According to the present invention, an organic thin layer having the dipole moment with the structure represented by the formula 43 below gathered to the interface on the light emitting layer side of the second electrode 6 (cathode) is formed.
Y′—Ar—X′ 43

In the formula 43, the linking group Y′ bonds with the cathode surface so that an organic thin layer having the dipole moment can be formed by gathering the same. As mentioned above, “the monomolecular film” in this case denotes a thin film having the thickness corresponding to the size of one molecule. Although the structure represented by the formula 43 may be partially bonded covalently so as to form a diner, trimer or oligomer like structure, the thickness of the layer is of the one molecule size.

In general, the linking group Y′ is linked by the reaction with a reactive functional group (in many cases a hydroxyl group) present on the cathode surface. FIG. 3 shows a schematic diagram of the organic thin layer 5 having the dipole moment formed on the surface of the cathode 6 provided by orienting the linking group Y′ and the substituent group X′ on the both sides of Ar comprising an aromatic hydrocarbon ring or an aromatic heterocycle. According to the electric field by the electrical double layer comprising the organic thin layer 5 having the dipole moment, the work function of the cathode 6 can be reduced.

The linking group Y′ is a group containing at least an oxygen atom and a halogen atom. It is selected preferably from the groups represented by the formula 42 as mentioned above.

Ar is a divalent aromatic hydrocarbon ring or an aromatic heterocycle having a substituent X. It is preferably a divalent group comprising a 5 to 6 membered single ring, or bonding the same by 2 or 3 by condensation or directly. Particularly, a benzene, a naphthalene, a biphenyl, an anthracene, a thiophene, a furan, a pyridine or the like is preferable.

As the substituent group X′, there may be preferably a hydrogen atom; a halogen atom such as a chlorine atom or the like; a nitro group; an alkyl group having 1 to 6 carbon atoms such as a methyl group, an ethyl group or the like; an aralkyl group such as a benzyl group or the like; an alkenyl group such as a vinyl group or the like; a cyano group; an alkynyl group such as an acetylene group or the like; an amide group; an acyl group such as an acetyl group or the like; an alkoxy carbonyl group having 1 to 6 carbon atoms such as a methoxy carbonyl group, an ethoxy carbonyl group or the like; a carboxyl group; an alkoxy group having 1 to 6 carbon atoms such as a methoxy group, an ethoxy group or the like; an aryloxy group such as a phenoxy group, a benzyloxy group or the like; a haloalkyl group such as a trifluoro methyl group or the like; a thiocyano group; an alkyl sulfonyl group such as a methane sulfonyl group or the like; or a sulfone amide group. Particularly, it is preferably selected from a halogen atom, a haloalkyl group, a cyano group and a nitro group.

As the substituent group X′, particularly, an electron donating group is preferably selected among the above-mentioned groups. Here, the electron donating group is a substituent group having a negative Harmett constant (σm, σp). According to the present invention, since the compound 43 having the Ar portion as a pie covalent system is used, the electrical double layer effect can be sufficiently utilized without the insulating material formation as in the non covalent system straight chain alkyl compound in the Ar portion.

Moreover, the organic thin layer having the dipole moment of the formulae 44 to 50 below can also be used as the positive hole injection film or the electron injection film:

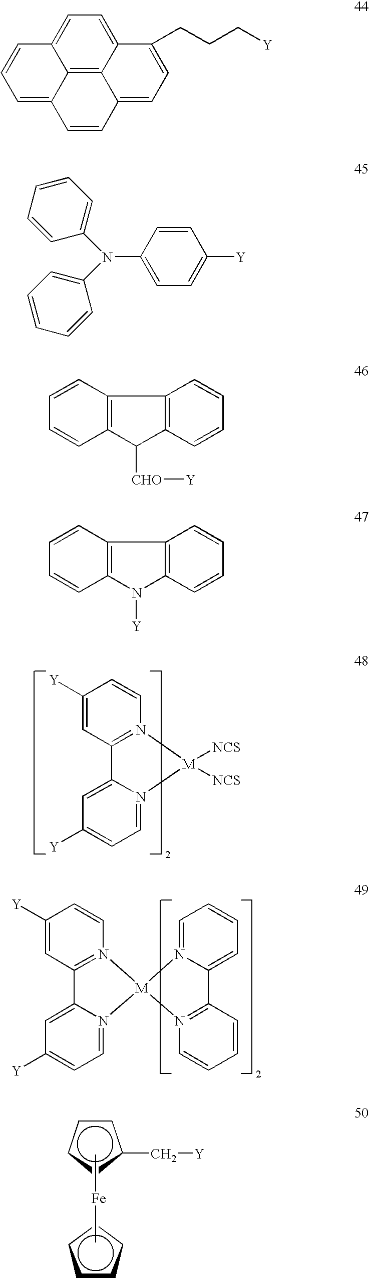

In the formulae, Y is same as Y and Y′ in the aforementioned formulae, and each of Z1 and Z2 independently represents a halogen atom. A chlorine atom is particularly preferable. As M, at least one of Ru(II), Os(II), Cr(II) or the like may be used preferably.

Moreover, an organic thin layer comprising an ion pair represented by the formula 51 below can be used as a positive hole injection film or an electron injection film. In the formula 51, at least one of Ru(II), Os(II), Cr(II) or the like can be used as M.

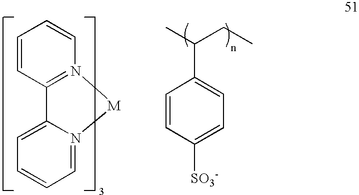

It was found out that the organic thin layer formed by the formula 51 can be used preferably as the charge injection layer for the light emitting layer comprising the liquid crystalline organic material, and it can be used also preferably as the charge injection layer for the light emitting layer formed with a non liquid crystalline conventional organic material. As a result, the organic thin layer formed by the formula 51 can be used as the charge injection layer having the dipole moment with the electrical double layer effect on the surface of the light emitting layer side of the anode and/or the cathode even when the light emitting layer is formed with an organic material other than the liquid crystalline organic material so that an organic EL element comprising a novel organic thin layer having the dipole moment. According to the organic thin layer, since the organic thin layer having the dipole moment capable of reducing the difference of the work function of the electrode and the work function of the light emitting layer between the first electrode and the light emitting layer and/or between the second electrode and the light emitting layer (that is, capable of reducing the charge injection barrier present therebetween), the charge injection to the light emitting layer can be facilitated according to the function of the organic thin layer.

(Production Method for the Organic EL Element)

As the first embodiment of the production method, an organic EL element 10 of the present invention is produced by forming organic thin layers 3 and 5 having a dipole moment on a substrate plate 1 having a first electrode 2 and/or a substrate plate 7 having a second electrode 6, disposing the substrate plates 1 and 7 so as to face the electrodes 2 and 6 each other while forming a gap portion, and injecting a liquid crystalline organic material for a light emitting layer containing a liquid crystal line organic semiconductor material and a light emitting material to the gap portion between the electrodes to form a light emitting layer 4.

As the second embodiment of the production method, an organic EL element 10 of the present invention is produced by forming organic thin layers 3 and 5 having a dipole moment on a substrate plate 1 having a first electrode 2 and/or a substrate plate 7 having a second electrode 6, applying a liquid crystalline organic material for a light emitting layer containing a liquid crystalline organic semiconductor material and a light emitting material on the first electrode 2 or the second electrode 6 to form a light emitting layer 4, and disposing the substrate plates 1 and 7 so that the electrodes 2 and 6 are faced each other.

As the third embodiment of the production method, an organic EL element 10 of the present invention is produced by forming an organic thin layers 3 and 5 having a dipole moment on a substrate plate 1 having a first electrode 2 and/or a substrate plate 7 having a second electrode 6, laminating a liquid crystalline organic material for a light emitting layer containing a liquid crystalline organic semiconductor material and a light emitting material on the first electrode 2 or the second electrode 6 to form a light emitting layer 4, and disposing the substrate plates 1 and 7 so that the electrodes 2 and 6 are faced each other.

According to the production methods of the first to third embodiments, an organic EL element without the damage by the deposition as in the conventional embodiments can be produced easily. As to the organic thin layer forming liquid having the dipole moment containing an organic compound having the electric dipole moment represented by a vector having its absolute value between 1 debye and 50 debye for forming the organic thin layers 3 and 5 having the dipole moment, it can be formed by applying or depositing on the electrode on the substrate plate.

The composition of the organic thin layer forming liquid having the dipole moment comprises by the ratio of 0.01 to 100 mM.

Moreover, as to the gap portion between the substrate plates at the time of injecting the liquid crystalline organic material for the light emitting layer, for instance in Example to be hereinafter described, a predetermined gap portion can be provided between the substrate plates by attaching a thermosetting type sealing material including a spacer of about 1 μm on the four corners on the surface of two substrate plates with an organic thin layer having a dipole moment formed, disposing the two substrate plates so as to face the electrodes on the inner side, and heat-curing the thermosetting resin to fix the substrate plates.

As heretofore explained, according to the organic EL element of the present invention, since the organic thin layer having the dipole moment functions as the charge injection layer, the charge injection to the light emitting layer can be facilitated. Moreover, since the light emitting layer is formed by injecting the light emitting layer forming material containing the liquid crystalline organic semiconductor material into the gap between the substrate plates. Thus, the damage of the organic thin layer having the dipole moment due to the conventional deposition cannot be generated so that the charge injection efficiency cannot be decreased. Furthermore, since the light emitting layer having high charge mobility can be formed, a thick light emitting layer can be formed. As a result, the problem of the short circuit between the electrodes or the like can be eliminated, and furthermore, an organic EL element having a good production process handling can be formed.

According to the method for producing an organic EL element of the present invention, an organic EL element without the damage due to the deposition such as in the conventional embodiments can be produced easily. Moreover, since the organic thin layer having the dipole moment is stable even when it is exposed in the production process, the necessity of cautiousness in handling can be reduced to some extent, and the light emitting characteristic of the organic EL element can be stabilized.

### EXAMPLES

Next, the present invention will be explained further in detail with reference to the examples. The present invention is not limited to the mention of the examples hereafter unless it is beyond the gist thereof.

### Example 1

An ITO substrate plate (manufactured by Sanyo Vacuum Industries Co., Ltd., sheet resistance; 10 Ω) with an ITO thin film formed on a substrate plate made of a non alkaline glass was used. After washing the ITO substrate with an acetone for 10 minutes by ultrasonic waves, with a semico clean liquid crystalline substrate plate washing liquid for 10 minutes by ultrasonic waves, and with pure water for 10 minutes by ultrasonic waves, it was washed in an isopropyl alcohol for 10 minutes by ultrasonic waves. Further, the ITO substrate plate was treated with a boiling process in an isopropyl alcohol and dried on a hot plate heated at 120° C. for 30 minutes, and a UV/ozone washing was performed for 15 minutes.

After dipping the thus washed ITO substrate plate in a dehydrated 1,2-dichloromethane liquid prepared by dissolving a 4-chlorophenyl-phosphorodichloridate (hereinafter, it is abbreviated as a CIBP) by a 5 mM concentration for 5 minutes, it was washed with a dehydrated 1,2-dichloromethane liquid, and dried with a dry nitrogen so as to form an organic thin layer 3 having a dipole moment of the CIBP as the positive hole injection film on the ITO electrode (anode 2).

### Example 2

In the same manner as in the example 1, after dipping the washed ITO substrate plate in a 1,2-dichloromethane liquid prepared by dissolving a fluorenylmethyl chloroformate (hereinafter, it is abbreviated as a FCCL) by a 1 mM concentration for 5 minutes, it was washed with a dehydrated 1,2-dichloromethane liquid, and dried with a dry nitrogen so as to form an organic thin layer 5 having a dipole moment of the FCCl as the electron injection film on the ITO electrode (cathode 6).

(Work Function of the Organic Thin Layer Having the Dipole Moment and the XPS Measurement)

In the examples 1 and 2, the ionizing potential of the organic thin layer having the dipole moment in a state formed on the ITO substrate plate was measured by AC-1 (manufactured by Riken Keiki Co., Ltd., atmospheric ultraviolet ray electron analysis device). As a result, the work function of the ITO electrode without the formation of the organic thin layer having the dipole moment was 5.0 eV. On the other hand, the work function of the organic thin layer having the dipole moment comprising the CIBP (positive hole injection film) was 5.5 eV, and the work function of the organic thin layer having the dipole moment comprising the FCCl (electron injection film) was 4.6 eV. Moreover, the presence of the organic thin layer having the dipole moment of the CIBP was confirmed by the XPS measurement. As a result, the elements of P (phosphorus) and Cl (chlorine) were confirmed, thereby, the formation of the organic thin layer having the dipole moment on the ITO substrate plate was confirmed.

### Example 3

An ITO substrate plate with an indium-tin oxide (ITO) transparent electrode laminated on a non alkaline glass substrate plate (manufactured by EHC, sheet resistance: 100 Ω) was used. After washing the ITO substrate with an acetone, Sernico clean (manufactured by Fruuchi Chemical Corporation), and pure water, it was washed in an isopropyl alcohol for 10 minutes by ultrasonic waves. Further, the ITO substrate was treated with a boiling process in an isopropyl alcohol and dried on a hot plate heated at 120° C., and a UV/ozone washing was performed for 15 minutes.

After dipping the washed ITO substrate plate in a dehydrated 1,2-dichloromethane liquid prepared by dissolving a CIBP by a 5 mM concentration for 5 minutes, it was washed with a dehydrated 1,2-dichloromethane liquid, and dried with a dry nitrogen so as to form an organic thin layer 3 having a dipole moment of the CIBP as the positive hole injection film on the ITO electrode (anode 2). Moreover, as mentioned above, after dipping the washed ITO substrate plate in a 1,2-dichloromethane liquid prepared by dissolving a FCCl by a 1 mM concentration for 5 minutes, the ITO substrate was washed with a dehydrated 1,2-dichloromethane liquid, and dried with a dry nitrogen so as to form an organic thin layer 5 having a dipole moment of the FCCl as the electron injection film on the ITO electrode (cathode 6).

A thermosetting type sealing material including a 2 μm spacer was attached to the four corners on the surface of the two ITO substrates with the organic thin layers 3 and 5 having the dipole moment formed, and the two ITO substrate plates were disposed so as to face with each other with the electrodes disposed on the inner side. Thereafter, with the ITO substrate plates pressed by a clip, they were heated by a 60° C. oven for 1 minute, and further heated by a 140° C. oven for 1 hour so as to harden the thermosetting type sealing material for fixing the substrate plates.

Next, with the fixed substrate plates placed on a 140° C. hot plate, the solid component of a 6-(4′-octyl phenyl)-2-butyloxy naphthalene (8-PNP-04) with a coumarin molecule represented by the formula 52 (7-alkoxy-3-(5-alkyl-2-thienyl)-coumarin) as the light emitting material to provide the light emission center mixed by 1 wt % was injected into the cell by the capillary pipe phenomenon so as to produce an organic EL element with a light emitting layer of a 1 mm×1 mm size and a 2 μm thickness formed. The charge mobility of the light emitting layer 4 was measured by the TOF method, and as a result it was found to be about 10⁻² cm²/Vs.

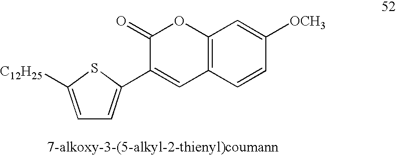

### Example 4

In the same manner as in the example 3, an organic EL element without forming the organic thin layer 5 having the dipole moment of the FCCl as the electron injection film was produced on the ITO electrode (cathode 6) so as to produce an organic EL element of the example 4. The other procedure was same as the example 3.

### Comparative Example 1

In the same manner as in the example 3, an organic EL element without forming the organic thin layers 3 and 5 having the dipole moment was produced on the ITO electrode so as to produce an organic EL element of the comparative example 1. The other procedure was same as the example 3.

(Characteristic Evaluation of the Organic EL Element)

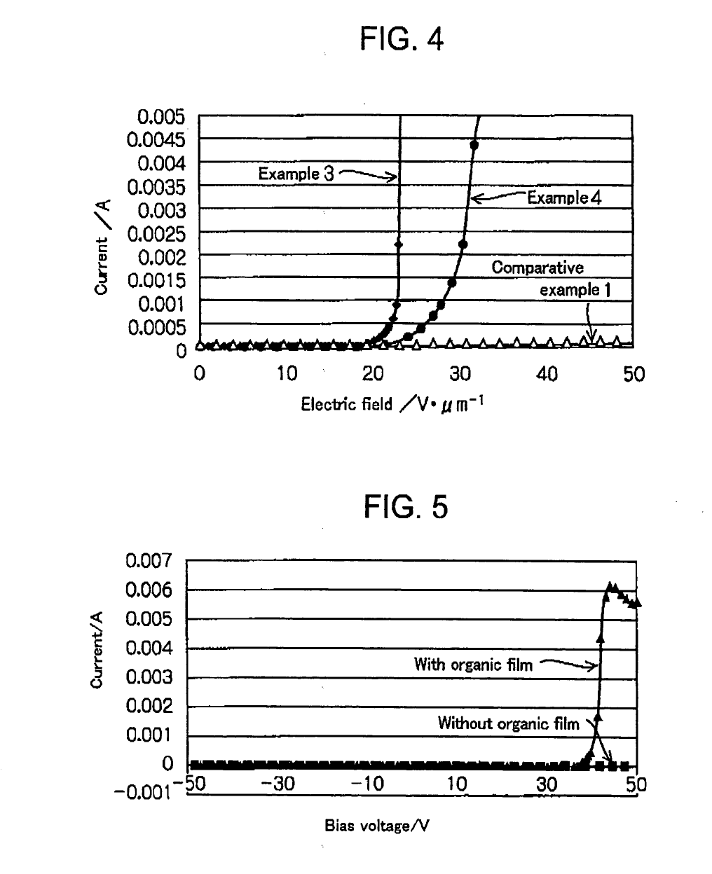

Using the organic EL elements of Examples 3 and 4, and Comparative example 1, a positive direction voltage was applied to the anode to the cathode thereof for evaluating the characteristics. The measurement was executed under the nitrogen atmosphere. FIG. 4 is a graph showing the electric field-electric current characteristic of the organic EL elements.

As it is apparent from the result of FIG. 4, the organic EL elements provided with the organic thin layer having the dipole moment has the electric current raised at about 20 V/μm and improvement of the charge injection efficiency was confirmed when compared with the organic EL element of the comparative example 1 not provided with the organic thin layer having the dipole moment.

### Example 5

In the same manner as in the example 3 except that the coumarin molecule was not doped, an organic EL element of the example 5 was produced. The other procedure was same as the example 3. The charge mobility of the light emitting layer 4 was measured by the time of flight method, and the result was about 10⁻² cm²/Vs.

### Comparative Example 2

In the same manner as in the example 3 except that the organic thin layers 3 and 5 having the dipole moment were not formed on the ITO electrode and furthermore the coumarin molecule was not doped, an organic EL element of the comparative example 2 was produced. The other procedure was same as the example 3.

(Characteristic Evaluation for the Organic EL Element)

Using the organic EL elements of Example 5 and Comparative example 2, a positive direction voltage was applied to the anode to the cathode thereof for evaluating the characteristics. The measurement was executed under the nitrogen atmosphere. FIG. 5 is a graph showing the electric field-electric current characteristic of the organic EL elements.

As it is apparent from the results of FIG. 5, the electric current rise was confirmed in the vicinity of 40V even when the coumarin molecule was not doped, and the charge injection effect was confirmed.

In the case an organic thin layer having the dipole moment was provided, the rectifying property was observed, however, in the case it was not provided, a symmetrical voltage-electric current curve was observed. Moreover, in the case the organic thin layer having the dipole moment was provided, the light emission derived from the 8-PNP-04 was confirmed even without doping the coumarin molecule.

(Clarification of the Light Emitting Mechanism of the Light Emission Center)

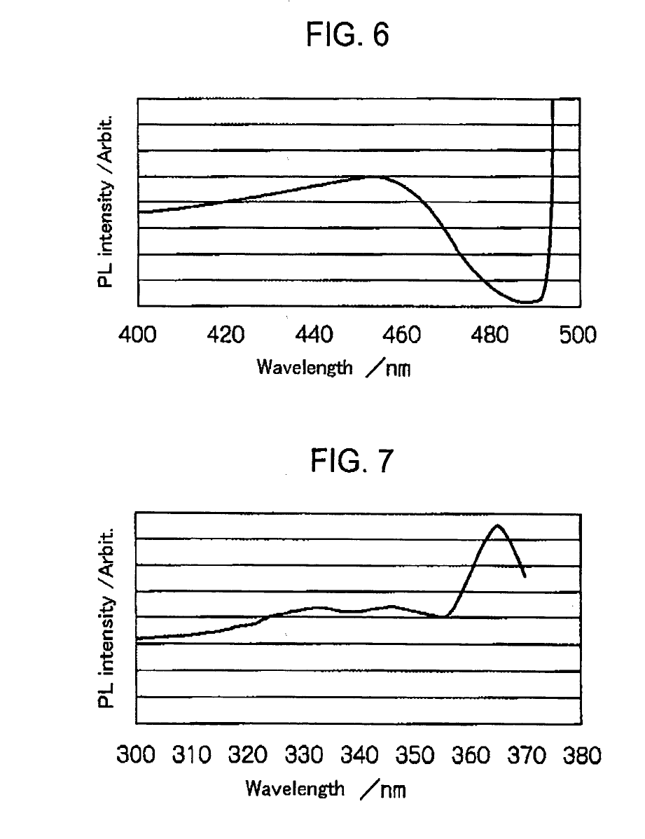

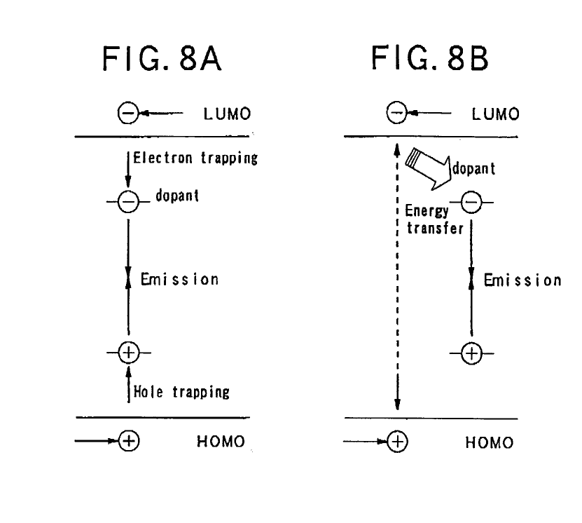

The light emitting mechanism of the organic EL element of the present invention was clarified by the PL (photoluminescence) measurement. As a result, the results shown in FIGS. 6 and 7 were obtained. From the results, two kinds of light emitting mechanisms shown in FIG. 8 were considered. As shown in FIG. BA, one is the case of moving the positive hole and the electron in the HOMO and LUMO of the 8-PNP-04, trapping by the energy level of the doped coumarin molecule and emitting the light by the coumarin molecule itself. As shown in FIG. 8B, the other one is the case of emitting the light by the 8-PNP-04 itself and emitting the light by the coumarin molecule by the energy transfer.

1. An organic electroluminescent element provided with a substrate plate having a first electrode, a substrate plate having a second electrode, and a light emitting layer comprising a liquid crystalline organic material and disposed between the substrate plates, wherein an organic thin layer having dipole moment is formed between the first electrode and the light emitting layer and/or between the second electrode and the light emitting layer.

2. An organic electroluminescent element according to claim 1, wherein the liquid crystalline organic material contains a liquid crystalline organic semiconductor material.

3. An organic electroluminescent element according to claim 2, wherein the liquid crystalline organic semiconductor material has a liquid crystalline molecule comprising a framework structure containing “L” pieces of 6π-electron system aromatic ring, “M” pieces of 8π-electron system aromatic ring, “N” pieces of 10π-electron system aromatic ring, “O” pieces of 12π-electron system aromatic ring, “P” pieces of 14π-electron system aromatic ring, “Q” pieces of 16π-electron system aromatic ring, “R” pieces of 18π-electron system aromatic ring, “S” pieces of 20π-electron system aromatic ring, “T” pieces of 22π-electron system aromatic ring, “U” pieces of 24π-electron system aromatic ring, “V” pieces of 26π-electron system aromatic ring, wherein L, M, N, O, P, Q, R, S, T, U and V respectively represent an integer number from 0 to 6; and L+M+N+O+P+Q+R+S+T+U+V=1 to 6, and chain molecule(s) introduced to a terminal or both terminals of the framework structure.

4. An organic electroluminescent element according to claim 2, wherein the liquid crystalline organic semiconductor material has smectic phase.

5. An organic electroluminescent element according to claim 1, wherein the light emitting layer has charge mobility of 10⁻⁶ cm²/V·s or more.

6. An organic electroluminescent element according to claim 1, wherein the light emitting layer contains a light emitting material which is a fluorescence low molecular or high molecular compound.

7. An organic electroluminescent element according to claim 1, wherein the organic thin layer comprises an organic compound having electric dipole moment represented by a vector having absolute value between 1 debye and 50 debye.

8. An organic electroluminescent element according to claim 1, wherein the organic thin layer comprises an organic compound having the electric dipole moment represented by a vector having absolute value between 1 debye and 50 debye, and wherein the vector is directed in such a manner that a positive electrode of the organic compound is located at anode side of the first electrode and the second electrode, and a negative electrode of the organic compound is located at the side of the light emitting layer.

9. An organic electroluminescent element according to claim 1, wherein the organic thin layer comprises an organic compound having the electric dipole moment represented by a vector having absolute value between 1 debye and 50 debye, and wherein the vector is directed in such a manner that a negative electrode of the organic compound is located at cathode side of the first electrode and the second electrode, and a positive electrode of the organic compound is located at the side of the light emitting layer.

10. An organic electroluminescent element provided with a substrate plate having a first electrode, a substrate plate having a second electrode, and a light emitting layer comprising an liquid crystalline organic material and disposed between the substrate plates, wherein an organic thin layer comprising an ion pair represented by the formula below is formed between the first electrode and the light emitting layer and/or between the second electrode and the light emitting layer. 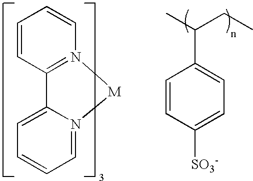
wherein, M is Ru(II), Os(II), or Cr(II).

11. A method for producing an organic electroluminescent element comprising a step (A) and any step of (B₁), (B₂) or (B₃) following the step (A):
(A) forming an organic thin layer having a dipole moment on a substrate plate having a first electrode and/or a substrate plate having a second electrode;
(B₁) disposing the substrate plates so as to face the electrodes each other while forming a gap portion, and injecting a liquid crystalline organic material for a light emitting layer containing a light emitting material to the gap portion between the electrodes to form a light emitting layer;
(B₂) applying a liquid crystalline organic material for a light emitting layer containing a light emitting material on the first electrode or the second electrode to form a light emitting layer, and disposing the substrate plates so that the electrodes are faced each other; and
(B₃) laminating a liquid crystalline organic material for a light emitting layer containing a light emitting material on the first electrode or the second electrode to form a light emitting layer, and disposing the substrate plates so that the electrodes are faced each other.

12. A method for producing an organic electroluminescent element according to claim 11, wherein the organic thin layer is formed by coating, depositing, spin coating, dipping or printing with the use of a liquid for forming an organic thin layer containing an organic compound having electric dipole moment.

13. A method for producing an organic electroluminescent element according to claim 12, wherein the organic compound is represented by a vector having absolute value between 1 debye and 50 debye.

14. A method for producing an organic electroluminescent element according to claim 11, wherein the liquid crystalline organic material for a light emitting layer contains a liquid crystalline organic semiconductor material.

15. A method for producing an organic electroluminescent element according to claim 14, wherein the liquid crystalline organic semiconductor material has a liquid crystalline molecule comprising a framework structure containing “L” pieces of 6π-electron system aromatic ring, “M” pieces of 8π-electron system aromatic ring, “N” pieces of 10π-electron system aromatic ring, “O” pieces of 12π-electron system aromatic ring, “P” pieces of 14π-electron system aromatic ring, “Q” pieces of 16π-electron system aromatic ring, “R” pieces of 18π-electron system aromatic ring, “S” pieces of 20π-electron system aromatic ring, “T” pieces of 22π-electron system aromatic ring, “U” pieces of 24π-electron system aromatic ring, “V” pieces of 26π-electron system aromatic ring, wherein L, M, N, O, P, Q, R, S, T, U and V respectively represent an integer number from 0 to 6; and L+M+N+O+P+Q+R+S+T+U+V=1 to 6, and chain molecule (s) introduced to a terminal or both terminals of the framework structure.
